(19) United States
(12) Patent Application Publication
(10) Pub. No.: US 2026/0116132 A1
(43) Pub. Date: Apr. 30, 2026

(54) COUPLING MODULE AND COMMERCIAL VEHICLE

(71) Applicant: DEERE & COMPANY, MOLINE, IL (US)

(72) Inventors: Thomas W. Schwalm, Edingen-Neckarhausen (DE); Jonas L. Wolf, Mainz (DE); Jan M. Riffel, Mannheim (DE)

(21) Appl. No.: 19/318,664

(22) Filed: Sep. 4, 2025

(30) Foreign Application Priority Data
Sep. 19, 2024 (EP) 24201310.0

(51) Int. Cl. B60D 1/07; B60D 1/24

(52) U.S. Cl. CPC B60D 1/07; B60D 1/248

(57) ABSTRACT

A coupling module for releasable securing to a commercial vehicle includes a coupling device configured for releasable coupling to a trailer or a working device, and a sensor device including a carrier plate having at least one receiving bearing for receiving at least one load force sensor.

### CROSS-REFERENCE TO RELATED APPLICATIONS

This application claims priority to European Patent Application No. 24201310.0, filed Sep. 19, 2024, which is hereby incorporated by reference.

### FIELD OF THE DISCLOSURE

The disclosure relates to a coupling module for releasable securing to a commercial vehicle, and further relates to a commercial vehicle having a coupling module which is releasably secured thereto.

### BACKGROUND

Coupling modules which are secured to commercial vehicles have a coupling device which is configured for releasable coupling to a counter-coupling of a trailer or a towed working device. The trailer or the towed working device can thereby be coupled to the commercial vehicle acting as the towing vehicle. During towed travel and when stationary, load forces which are caused by the trailer or the towed working device act via the coupling module on the towing vehicle and can influence the state or travel behavior thereof.

### SUMMARY

According to an aspect of the present disclosure, a coupling module for releasable securing to a commercial vehicle includes a coupling device configured for releasable coupling to a trailer or a working device, and a sensor device including a carrier plate having at least one receiving bearing for receiving at least one load force sensor.

According to an aspect of the present disclosure, a plurality of receiving bearings for at least one load force sensor are arranged in a circumferential direction of the carrier plate.

According to an aspect of the present disclosure, the carrier plate has a plurality of plate portions connected to each other in an angled manner in the circumferential direction.

According to an aspect of the present disclosure, a plate portion has at least two receiving bearings.

According to an aspect of the present disclosure, the receiving bearing has a recess arranged in the carrier plate.

According to an aspect of the present disclosure, the load force sensor is supported on an inner wall of the recess.

According to an aspect of the present disclosure, the spatial extent of the carrier plate is represented by an X direction, Y direction, and Z direction which are orientated at right-angles relative to each other, and wherein the frame plane of the carrier plate is located in a plane defined by the Y direction and the Z direction.

According to an aspect of the present disclosure, the coupling device is releasably connected to the carrier plate of the sensor device or is produced integrally.

According to an aspect of the present disclosure, the load force sensor has at least one expansion measurement strip.

According to an aspect of the present disclosure, a commercial vehicle includes a coupling module releasably secured to the commercial vehicle, and the coupling module includes a sensor device having a carrier plate which has at least one receiving bearing for receiving at least one load force sensor.

According to an aspect of the present disclosure, the coupling module is arranged between two carrier receptacles secured to the commercial vehicle and releasably fixed to these carrier receptacles.

According to an aspect of the present disclosure, at least one carrier receptacle is perforated in a transverse vehicle direction by a plurality of carrier holes arranged beside each other in a vertical vehicle direction, and wherein a carrier hole of the carrier receptacle is aligned in the transverse vehicle direction with an assembly hole of the coupling module.

According to an aspect of the present disclosure, the carrier hole and the assembly hole are passed through by an assembly bolt in the transverse vehicle direction.

According to an aspect of the present disclosure, the assembly bolt and the coupling module are passed through by a locking pin extending in the longitudinal vehicle direction.

According to an aspect of the present disclosure, the commercial vehicle is an agricultural towing vehicle.

The above and other features will become apparent from the following detailed description and accompanying drawings.

### BRIEF DESCRIPTION OF THE DRAWINGS

The disclosure will be explained in more detail hereunder with reference to the appended drawings. Components with identical or equivalent function herein are provided with the same reference signs. In the figures:

FIG. 1 shows a perspective, exploded view of the coupling module according to the disclosure in a first embodiment;

FIG. 2 shows a perspective, exploded view of the coupling module according to the disclosure in another embodiment;

FIG. 3 shows a plan view of a sensor device as a component of the coupling module according to the disclosure;

FIG. 4 shows a sectioned side view of the sensor device according to the line of section IV-IV in FIG. 3;

FIG. 5 shows a perspective, sectioned view of the sensor device according to FIG. 3 with a plane of section extending parallel with the plane of the page of the drawing; and

FIG. 6 shows a perspective illustration of two carrier rails of an agricultural towing vehicle having a coupling module according to the disclosure which is releasably mounted thereon.

### DETAILED DESCRIPTION

The embodiments or implementations disclosed in the above drawings and the following detailed description are not intended to be exhaustive or to limit the present disclosure to these embodiments or implementations.

An object of the present disclosure is to detect in a technically simple manner load forces, which act on a commercial vehicle as part of a combination with the vehicle and trailer coupled together, of a trailer or a towed working device.

This object is achieved by a coupling module or a commercial vehicle having the features of one or more embodiments disclosed herein. One or more embodiments disclosed herein can relate to particularly advantageous embodiments of the disclosure.

According to an embodiment, a coupling module for releasable securing to a commercial vehicle is proposed. This coupling module has a coupling device and a sensor device. The coupling device is configured for releasable connection or coupling to a drawbar of a trailer or a towed working device. The sensor device contains a carrier plate which has at least one receiving bearing for receiving at least one load force sensor.

By means of the sensor device, the coupling module performs an additional sensor function in addition to the mechanical coupling function. Load forces which act on the commercial vehicle which acts as the towing vehicle can thereby be detected in a technically efficient manner with little complexity in terms of equipment.

The load force sensor generates (for example, optical or electrical) sensor signals which can be processed by suitable technical means (for example, a control unit including a processor and memory). The processed sensor signals may, for example, be used to record a current load force behavior on the commercial vehicle or a physical state of the commercial vehicle and/or of the coupling module or may be used as signals to control vehicle functions of the commercial vehicle. It is thereby possible to support the vehicle safety even under unfavorable load force conditions with little technical complexity.

For example, the coupling module can be used to monitor and comply with permitted support loads during operation of the commercial vehicle as the towing vehicle. Furthermore, the braking behavior of the towing vehicle during vehicle operation can be controlled and/or regulated in accordance with the detected load forces. Furthermore, the coupling module can support the technical development and verification of vehicle components in test centers. The load force data obtained can also be used to technically configure the durability of load-bearing vehicle components.

Trailers or working devices which are towed by the towing vehicle can perform various functions. While the trailer can be limited to a transport function for different products, the towed working device can have a specific working function. For example, the working device is in the form of a mixer wagon, a field sprayer, a baling press or a manure trailer.

In an embodiment, a plurality of receiving bearings are arranged in a state distributed in a circumferential direction of the carrier plate. Each receiving bearing serves to receive at least one load force sensor. The positioning of a plurality of load force sensors within the sensor device allows a more precise detection of the load forces. For example, individual, differently orientated load force components can be detected.

In some embodiments, the carrier plate has in the circumferential direction a plurality of plate portions which are connected to each other in an angled manner. As a result of this construction, a plurality of load force sensors can be arranged in a state distributed along the individual plate portions so that load forces or current load force profiles on the commercial vehicle with respect to the different orientation of the force components can be detected with a particularly high level of precision.

Advantageously, two adjacent plate portions of the carrier plate are arranged at right-angles to each other. For example, the carrier plate has a rectangular or square plate cross section.

In another embodiment, a plate portion of the carrier plate, for example each plate portion, has at least two receiving bearings for each receiving a load force sensor. It is thereby possible to detect load forces which act on the commercial vehicle and the force components thereof even more precisely.

In some embodiments, the receiving bearing has a recess in or on the material of the carrier plate. For example, this recess forms the receiving bearing for receiving at least one load force sensor. The recess has, for example, a slot-like or a rectangular cross section. The recess can be produced, for example, by milling the material of the carrier plate.

Advantageously, at least two recesses with different recess directions are provided on the carrier plate. This allows load force sensors which are arranged and/or orientated differently in specific areas of the carrier plate, for example, on a plate portion. The carrier plate can thereby receive a plurality of load force sensors in a very space-saving manner. Accordingly, the sensor device can detect differently orientated force components with space-saving dimensions.

In some embodiments, the load force sensor is supported on an inner wall of the recess. This bearing or positioning of the load force sensor can support a particularly sensitive detection of physical changes of the carrier plate, such as load forces, material expansions and shear stresses.

For example, the coupling module allows a three-axial force measurement, that is to say, a measurement of three independent force components which are introduced by the coupling device into the commercial vehicle. In this instance, the spatial extent of the carrier plate can be represented by an X, Y and Z direction, wherein the frame plane of the carrier plate is located in a plane defined by the Y direction and the Z direction. In this case, the Y direction and the Z direction are arranged in the manner of a coordinate system at right-angles to each other and also at right-angles to an X direction. In this case, the X direction is orientated in the operating state of the coupling module in parallel with a longitudinal axis or longitudinal direction of the commercial vehicle. The Y direction extends in parallel with a transverse axis or transverse direction of the commercial vehicle while the Z direction is arranged in parallel with a vertical axis or vertical direction of the commercial vehicle. In this manner, load forces which act can be detected with a corresponding spatial arrangement of the load force sensors with respect to the X, Y and Z components thereof.

Advantageously, the coupling device and the carrier plate of the sensor device are releasably connected to each other. The sensor function can thereby be combined with different coupling devices in a technically simple manner. Consequently, the coupling module can be used for extremely different trailers or types of trailer (for example, rigid drawbar trailers, articulated drawbar trailers). Alternatively, the coupling device is integrally produced with the carrier plate of the sensor device.

In another embodiment, the load force sensor has at least one expansion measurement strip. For example, the load force sensor comprises at least one such expansion measurement strip. The expansion measurement strip is for example in the form of an optical or electrical expansion measurement strip. Load forces which are introduced into the coupling module cause shear stresses in the region of the receiving bearings present. In the event of such load forces or material expansions occurring, the expansion measurement strip generates corresponding signals which are processed in a suitable manner. In this case, the sensor signals can be detected by a measurement amplifier and processed by downstream functional units (for example, for recording, regulation, control).

The disclosure further relates to a commercial vehicle having a coupling module releasably secured thereto according to any one of the embodiments disclosed herein. The commercial vehicle according to the disclosure has the above-described advantages of the coupling module according to the disclosure. In this case, the coupling module contains a sensor device having a carrier plate which has at least one receiving bearing for receiving at least one load force sensor. By means of the coupling module and the at least one load force sensor thereof, a cost-effective technical functional unit is provided for generating current load force data. In accordance with these load force data, the travel state of the commercial vehicle and the travel behavior thereof can be advantageously supported in technical safety terms while a trailer or working device is being towed, for example, in order to monitor and comply with permitted support loads or also to adapt or regulate the travel behavior.

In some embodiments, the coupling module, for example the sensor device thereof, is arranged between two carrier receptacles which are secured to the commercial vehicle and releasably fixed to these carrier receptacles. In this instance, mechanical carrier receptacles (for example, carrier rails) which are present as standard in the rear area of the commercial vehicle (for example, a tractor) can be used and can support a mechanically stable fixing of the sensor device and the entire coupling module.

Alternatively to the above-mentioned arrangement of the coupling module in the rear region of the commercial vehicle, the coupling module can also be positioned in a suitable technical manner in the front region of the commercial vehicle.

Advantageously, at least one carrier receptacle, for example both carrier receptacles, is/are perforated in a transverse vehicle direction by a plurality of carrier holes which are arranged beside each other in a vertical vehicle direction. In this case, a carrier hole of the carrier receptacle is aligned in the transverse vehicle direction with an assembly hole of the coupling module. The cooperation of the carrier holes of the carrier receptacles and assembly holes of the coupling module allows an ability of the coupling module to be adjusted in a simple and stable manner in technical assembly terms. This supports a compatible use of the coupling module for different trailer types, for example, a relatively low assembly position of the coupling module for rigid drawbar trailers and a relatively high assembly position of the coupling module for articulated drawbar trailers.

The coupling module can include a plurality of assembly holes, for example two assembly holes which are opposite each other in the transverse vehicle direction. The assembly holes present can perforate the coupling module, for example the sensor device, as perforations (for example, bores) or be in the form of recesses in the coupling module. In order to bring about the releasable fixing of the coupling module on the carrier receptacles, for example, a plug-fit or screw connection is provided.

For a releasable fixing of the coupling module in a technically simple manner in assembly terms, the carrier hole of the carrier receptacle and the associated assembly hole of the coupling module are passed though by an assembly bolt in an embodiment. With the assembly bolt, a mechanically stable and simultaneously cost-effective plug-fit or screw connection can be produced for the releasable fixing.

Advantageously, the releasable fixing of the coupling module and the positioning of the load force sensor are supported by the assembly bolt being releasably locked along the transverse vehicle direction. To this end, the assembly bolt and the sensor device can be passed through by a locking pin which extends in the longitudinal vehicle direction. The locking pin can again be releasably fixed in position by suitable mechanical means on the coupling module.

The commercial vehicle can be in the form of an agricultural towing vehicle, for example a hauling device or tractor. During travel when the vehicle and trailer are coupled together, any occurring load forces of the trailer or towed working device can be detected by the coupling module. The travel behavior of the towing vehicle can be improved accordingly while taking account of the detected and processed load forces.

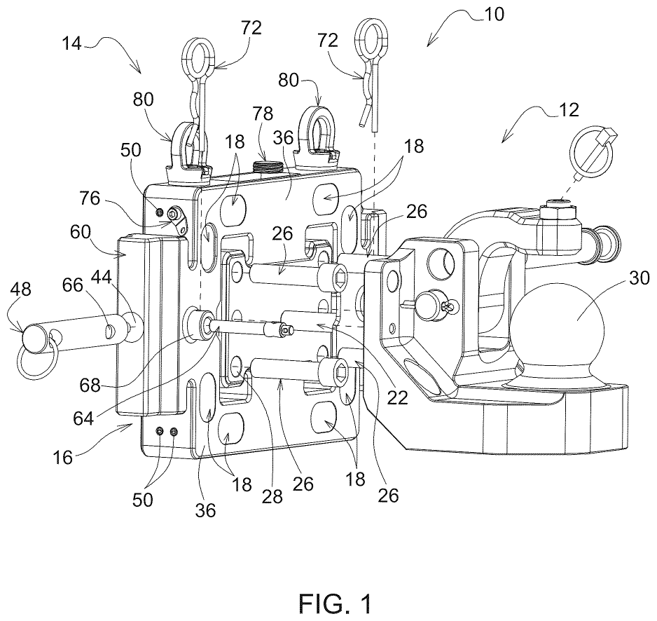

FIG. 1 shows a coupling module 10 having a coupling device 12 and a sensor device 14. The coupling device 12 is configured for releasable connection to a drawbar of a trailer or working device which is not illustrated here. The sensor device 14 has a carrier plate 16 which has a plurality of receiving bearings 18. The receiving bearings 18 are each used to receive at least one load force sensor 20 which can be in the form of an expansion measurement strip.

The coupling device 12 and the sensor device 14 can be releasably connected to each other. During assembly, the coupling device 12 can be fixed by means of two fixing bolts 22 to two fixing portions 24 of the carrier plate 16. By means of four fixing screws 26 and corresponding inner threads 28 on the fixing portions 24, the coupling device 12 and the sensor device 14 are releasably clamped together.

In FIG. 1, the coupling device 12 is provided with a coupling ball 30 for coupling a rigid drawbar trailer or towed working device.

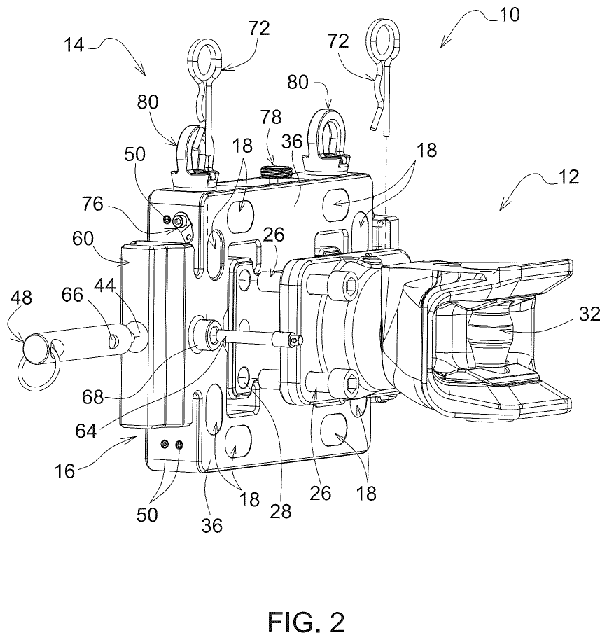

In FIG. 2, the coupling device 12 which is merely partially illustrated in detail is provided with an automatic bolt coupling 32. This coupling device 12 is usually used for an articulated drawbar trailer. Similarly to the embodiment according to FIG. 1, the coupling device 12 according to FIG. 2 can also be releasably connected to the sensor device 14 by the fixing screws 26.

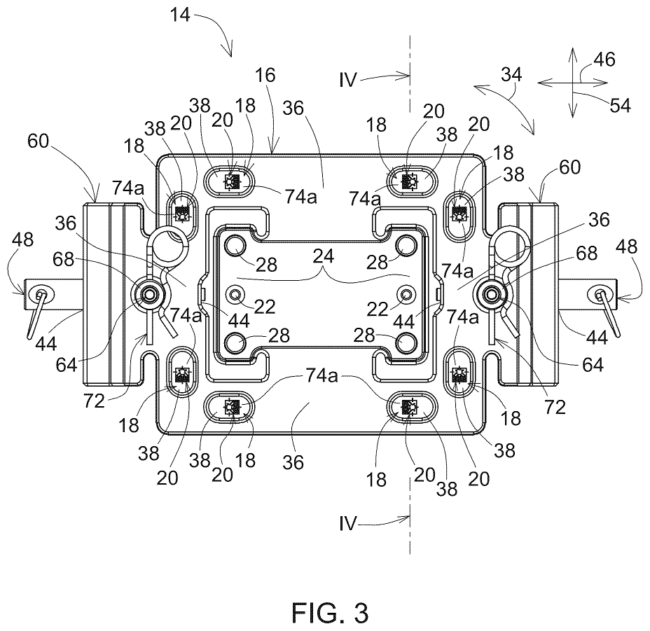

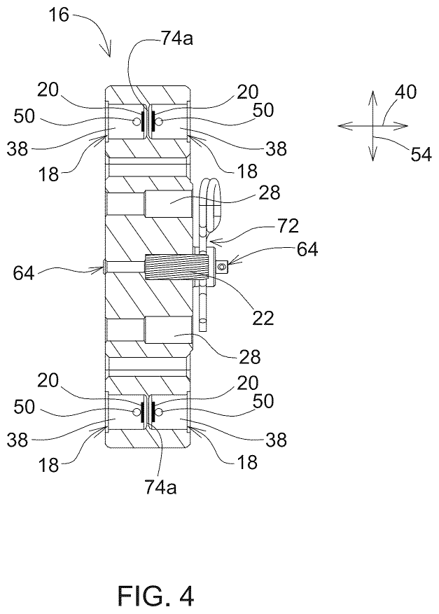

FIG. 3 shows the carrier plate 16 on which a plurality of receiving bearings 18 are arranged in a circumferential direction 34. The carrier plate 16 has in the circumferential direction 34 four plate portions 36 which are arranged at right-angles to each other and which are connected to each other. Each plate portion 36 contains four receiving bearings 18, of which two receiving bearings 18 are arranged at a front side and a rear side and positioned symmetrically relative to each other. A wall-like web 74a which separates two symmetrically arranged receiving bearings 18 from each other is arranged in the notional plane of symmetry (FIG. 4). The web 74a can be an integral material component of the carrier plate 16.

Alternatively, only one side (either the front side or the rear side) of the plate portion 36 has two receiving bearings 18 each having a web 74a or an inner wall for a load force sensor 20.

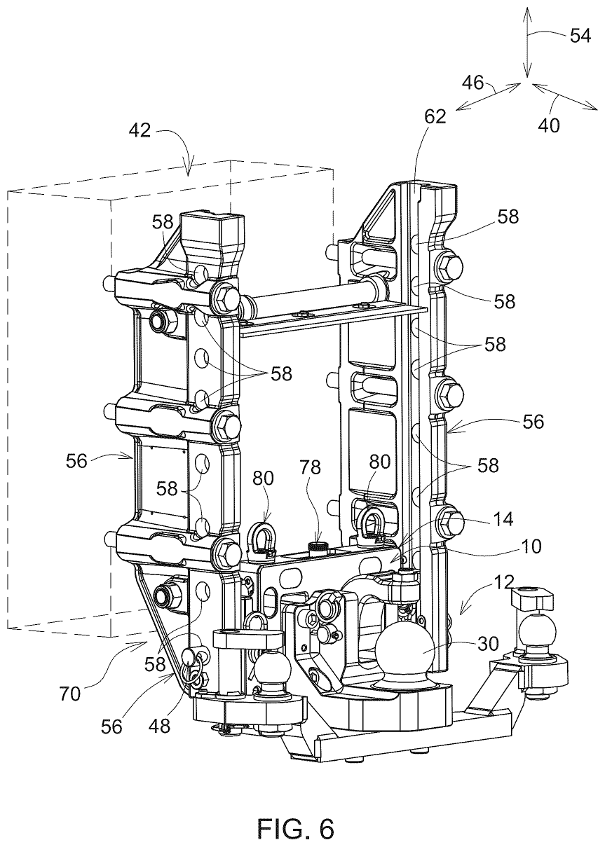

FIG. 4 shows that the receiving bearing 18 has a recess 38 or forms such a recess 38. The recess 38 is delimited by the web 74a which is active for the recess 38 as an inner wall. The load force sensor 20 is fixed or supported on the web 74a, for example, by adhesive bonding. The recess 38 passes through the carrier plate 16 in a longitudinal direction 40 or along a longitudinal axis of a commercial vehicle 42 which is only schematically indicated in FIG. 6. In FIG. 3, the recesses 38 are in the form of slot-like cross sections in the material of the carrier plate 16.

In FIG. 4, by way of example a plurality of line channels 50 which pass through the carrier plate 16 are illustrated. The line channels 50 which can be seen only partially in the drawings extend as far as at least one receiving bearing 18 and can receive or transfer sensor connections or connection lines (which can be optical or electrical) of the load force sensors 20.

A notional plate plane of the carrier plate 16 is defined by a transverse direction 46 or transverse axis and a vertical direction 54 or vertical axis, which is arranged at right-angles thereto, of the commercial vehicle 42. As a result of a corresponding arrangement or positioning of the load force sensors 20 in the carrier plate 16, a plurality of force components of the load forces, which act from the trailer or towed working device on the coupling module 10 or on the commercial vehicle 42, can be detected. Thus, for example, an X component (in the longitudinal direction 40), a Y component (in the transverse direction 46) and a Z component (in the vertical direction 54) of the load forces can be detected. With the load force sensors 20 which can be seen in FIG. 2, the Y component and the Z component of the load forces can be detected.

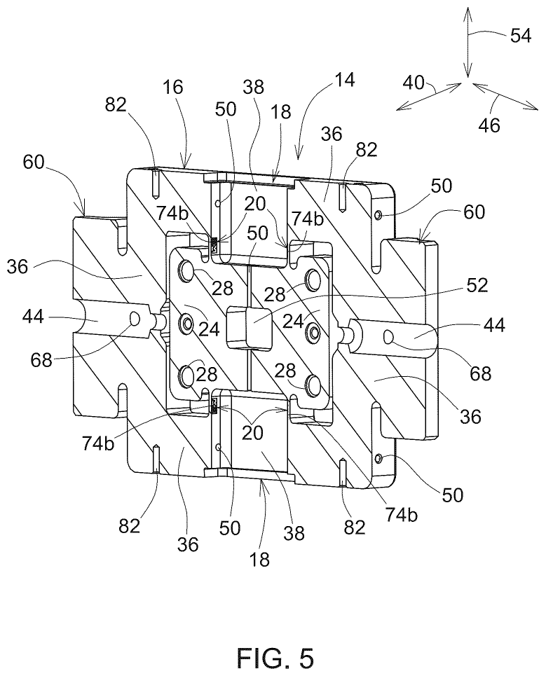

FIG. 5 shows the carrier plate 16 as a sectioned perspective view. The plane of section is located approximately in the same plane in which the webs 74a according to FIG. 4 are also located. FIG. 5 shows additional receiving bearings 18 or recesses 38, the inner walls of which have webs 74b. In the region of these webs 74b, additional load force sensors 20 are supported or fixed, for example, by adhesive bonding. With respect to the above-mentioned plane of section, the recesses 38 in FIG. 5 can be configured as mirror images and accordingly receive additional load force sensors 20 at webs 74b. Regardless of the number thereof, the load force sensors 20 on the webs 74b can be suitable for detecting the X component (in the longitudinal direction 40) of the load forces.

The receiving bearings 18 or recesses 38 both according to FIG. 4 and according to FIG. 5 can be closed outwardly by a closure member (for example, cover) and sealed.

FIG. 6 shows the schematically indicated commercial vehicle 42 with two carrier receptacles fixed thereto in the form of two carrier rails 56. The carrier rails 56 can be used in conjunction with a tractor 70 as an agricultural towing vehicle. The coupling module 10 is arranged between the two carrier rails 56 and releasably fixed to the two carrier rails 56. For this releasable fixing, carrier holes 58 which pass through the carrier rails 56 in the transverse direction 46 are used. The carrier holes 58 are arranged on each carrier rail 56 in a state beside each other in the vertical direction 54. In FIG. 6, the carrier holes 58 arranged in the lowest position of the two carrier rails 56 are used for the releasable fixing of the coupling module 10 so that a low position of the coupling module 10 is achieved. The carrier holes 58 allow a vertically adjustable positioning of the coupling module 10 so that, for example, the coupling module 10 according to FIG. 2 can be positioned in a higher position and can be used in conjunction with an articulated drawbar trailer or towed working device.

For the already mentioned releasable fixing of the coupling module 10 to the carrier rails 56, selected carrier holes 58 of the carrier rails 56 are aligned in the transverse direction 46 with assembly holes 44 of the coupling module 10. The assembly holes 44 extend in the transverse direction 46 both in the region of the plate portions 36 which extend parallel with the vertical direction 54 and in the region of two rail extension members 60 which are securely connected to these plate portions 36. The rail extension members 60 are located approximately in a form-fitting manner in rail channels 62 of the carrier rails 56.

For the releasable fixing of the coupling module 10 to the carrier rails 56, two assembly bolts 48 are used (FIG. 3). In this instance, each assembly bolt 48 extends in the transverse direction 46 through a selected carrier hole 58 and the assembly hole 44 which is aligned with this carrier hole 58 in the transverse direction 46. Each of the two assembly bolts 48 is locked in the transverse direction 46 by a locking pin 64 which extends in the longitudinal direction 40 extending through a locking hole 66 of the respective assembly bolt 48. In this case, the locking pin 64 also extends through the sensor device 14 in a transition region 68 between the rail extension member 60 and the adjacent plate portion 36. The locking pin 64 is again releasably fixed in position on the carrier plate 16 by a split pin 72 in a suitable mechanical manner.

For additional mechanical securing of the assembly bolt 48 and/or the locking pin 64 and/or the split pin 72, a retaining lug 76 which is fixed (for example, screwed) to the carrier plate 16 and which carries one or more chain-like retention member(s) which are not illustrated here is provided. The chain-like retention member(s) is/are used to suspend the assembly bolt 48 and/or the locking pin 64 and/or the split pin 72 so that moving components are avoided on the coupling module 10. In some embodiments, one retaining lug 76 is arranged in the transverse direction 46 at each of the two sides of the carrier plate 16.

The sensor connections or connection lines, which extend along the line channels 50, of the load force sensors 20 can be guided into the carrier plate 16 and/or out of the carrier plate 16 together or in a bundled state. To this end, a central plate region 52 (FIG. 5) and/or a guide connecting piece 78 (FIG. 1, FIG. 2) is provided.

Two drawbar eyelets 80 which are each screwed to an inner thread 82 of the carrier plate 16 can be connected to the carrier plate 16. The drawbar eyelets 80 are active as auxiliary transport and assembly members for the coupling module 10, for example, when the coupling module 10 is intended to be displaced into the rail channels 62 in the vertical direction 54.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A coupling module for releasable securing to a commercial vehicle, comprising:
a coupling device configured for releasable coupling to a trailer or a working device; and
a sensor device including a carrier plate having at least one receiving bearing for receiving at least one load force sensor.

2. The coupling module of claim 1, wherein a plurality of receiving bearings for at least one load force sensor are arranged in a circumferential direction of the carrier plate.

3. The coupling module of claim 1, wherein the carrier plate has a plurality of plate portions connected to each other in an angled manner in the circumferential direction.

4. The coupling module of claim 3, wherein a plate portion has at least two receiving bearings.

5. The coupling module of claim 1, wherein the receiving bearing has a recess arranged in the carrier plate.

6. The coupling module of claim 5, wherein the load force sensor is supported on an inner wall of the recess.

7. The coupling module of claim 1, wherein the spatial extent of the carrier plate is represented by an X direction, Y direction, and Z direction which are orientated at right-angles relative to each other, and wherein the frame plane of the carrier plate is located in a plane defined by the Y direction and the Z direction.

8. The coupling module of claim 1, wherein the coupling device is releasably connected to the carrier plate of the sensor device or is produced integrally.

9. The coupling module of claim 1, wherein the load force sensor has at least one expansion measurement strip.

10. A commercial vehicle, comprising:
a coupling module releasably secured to the commercial vehicle, the coupling module including a sensor device having a carrier plate which has at least one receiving bearing for receiving at least one load force sensor.

11. The commercial vehicle of claim 10, wherein the coupling module is arranged between two carrier receptacles secured to the commercial vehicle and releasably fixed to these carrier receptacles.

12. The commercial vehicle of claim 11, wherein at least one carrier receptacle is perforated in a transverse vehicle direction by a plurality of carrier holes arranged beside each other in a vertical vehicle direction, and wherein a carrier hole of the carrier receptacle is aligned in the transverse vehicle direction with an assembly hole of the coupling module.

13. The commercial vehicle of claim 12, wherein the carrier hole and the assembly hole are passed through by an assembly bolt in the transverse vehicle direction.

14. The commercial vehicle of claim 13, wherein the assembly bolt and the coupling module are passed through by a locking pin extending in the longitudinal vehicle direction.

15. The commercial vehicle of claim 10, wherein the commercial vehicle is an agricultural towing vehicle.
